(19) United States
(12) Patent Application Publication
(10) Pub. No.: US 2024/0270920 A1
(43) Pub. Date: Aug. 15, 2024

(54) ULTRAHIGH-STRENGTH SIO2 AEROGEL WITH ALTERNATELY CONFIGURED SOFT CHAINS AND HARD CORES, AND METHOD FOR PREPARING SAME

(71) Applicant: YANGTZE DELTA REGION INSTITUTE (QUZHOU) , UNIVERSITY OF ELECTRONIC SCIENCE AND TECHNOLOGY OF CHINA, Quzhou (CN)

(72) Inventors: Jiaxuan LIAO, Quzhou (CN); Xin LONG, Quzhou (CN); Lichun ZHOU, Quzhou (CN)

(73) Assignee: YANGTZE DELTA REGION INSTITUTE (QUZHOU) , UNIVERSITY OF ELECTRONIC SCIENCE AND TECHNOLOGY OF CHINA, Quzhou (CN)

(21) Appl. No.: 18/414,497

(22) Filed: Jan. 17, 2024

Related U.S. Application Data
(63) Continuation of application No. PCT/CN2023/083244, filed on Mar. 23, 2023.

(30) Foreign Application Priority Data
Feb. 11, 2023 (CN) 202310108166.4

(51) Int. Cl. C08J 9/28; C01B 33/158; C08G 77/20; C08G 77/392

(52) U.S. Cl. CPC C08J 9/28; C01B 33/1585; C08G 77/20; C08G 77/392; C01P 2004/03; C08J 2201/0502; C08J 2205/026; C08J 2383/04

(57) ABSTRACT

An ultrahigh-strength SiO₂ aerogel with alternately configured soft chains and hard cores, and a method for preparing same are provided. According to the present invention, firstly, octa-olefin functionalized silsesquioxane and a mercapto silane coupling agent are dissolved in an organic solvent under a protective gas to perform a catalytic reaction, and then the reaction system is dried to obtain a white powder; secondly, the white powder is dissolved in an alcohol solution, the mixture is stirred until the white powder is completely dissolved, and then an acid-catalyzed hydrolysis reaction and a heat-induced gelation reaction under an alkaline environment are performed to obtain a wet gel; and finally, the gel is subjected to aging, surface modification, displacement and vacuum lyophilization to obtain the ultrahigh-strength SiO₂ aerogel with alternately configured soft chains and hard cores.

### CROSS REFERENCE TO THE RELATED APPLICATIONS

This application is a continuation application of International Application No. PCT/CN2023/083244, filed on Mar. 23, 2023, which is based upon and claims priority to Chinese Patent Application No. 202310108166.4, filed on Feb. 11, 2023, the entire contents of which are incorporated herein by reference.

### TECHNICAL FIELD

The present invention relates to the technical field of functional nanoporous materials, and in particular to an ultrahigh-strength SiO₂ aerogel with alternately configured soft chains and hard cores, and a method for preparing same.

### BACKGROUND

SiO₂ aerogel has attracted much attention because of its high specific surface area, large pore volume, high porosity, low density, and three-dimensionally communicated nanoporous framework structure, etc., and is promising in fields such as energy, transportation, construction, clothing, piping insulation, electronics, aerospace, national defense and military industries. The SiO₂ aerogel was created in 1931, and the related preparation process and structure design thereof have tended to be mature. However, the high-porosity structure and the rigid framework structure lead to the limitations of the SiO₂ aerogel, such as high brittleness, weak deformability and poor processability, which have not been effectively overcome so far, being one of the biggest problems hindering the application of the aerogel. Generally, the SiO₂ aerogel only has a strength of about several kilopascals and a strain of no more than 5%, so it is difficult to be applied alone, and can only be compounded with an additional material to make a composite material such as an aerogel felt and an aerogel plate to be applied in practice. However, in essence, the composite process will seriously weaken the structural advantages of the aerogel, which makes it difficult to play the truly unique function of the aerogel, and cannot reflect the real application value of the aerogel.

In order to overcome this problem, researchers have used organosiloxanes with different numbers of elastic groups for SiO₂ aerogel preparation, which have a certain effect on the improvement of deformability, but have little effect on the improvement of strength, and the resulting products are still unable to meet the application requirements (Gen Hayase, Kazuyoshi Kanamori, Masashi Fukuchi, et al. Angew. Chem. Int. Ed. Engl. 2013, 52, 1986). In recent years, structural engineering design has opened up new horizons in aerogel structural design, and the resulting nanofiber aerogels, nanosheet aerogels and multi-dimensional coexisting aerogels show ultrastrong deformability due to the ultrahigh degree of freedom of motion of basic constituent units, with elastic compression strains reaching about 60% and ultimate compression strains even reaching 80% or more, demonstrating extremely high application potential (Y. Si, X., et al., Sci. Adv. 2018, 4, 8925; L. An, J. Wang, D. Petit, et al., Nano Lett. 2020, 20, 3828). However, the deformability of these aerogels is limited by their ultrahigh porosity of 99% or more, resulting in a significant weakening of strength, and aerogels designed by structural engineering are highly susceptible to damage when subjected to continuous moving or impact forces.

Due to the great difficulty in enhancing the strength of SiO₂ aerogels, there are few reports on improving the strength of the aerogels, and the studies are mainly focused on the design and preparation of C, Al₂O₃ and some organic aerogels. C, Al₂O₃ and composite aerogels usually require a sintering process after molding to effectively strengthen the neck region between the nanoparticles, thereby improving the strength. However, high-temperature sintering is prone to cause a disadvantage of high brittleness, which makes the aerogels still unable to meet the requirements of practical application (Shen Xiaodong et al., Journal of Nanjing University of Technology, 2012, 34, 26; Z. Yang, J. Li, X. Xu, et al., J. Mater. Sci. Technol. 2020, 50, 66). Moreover, high-temperature treatment involves excessive consumption of energy, and is not in line with energy conservation and emission reduction. In addition, high-strength organic aerogels such as polyimide aerogels not only have higher strength, but also have certain toughness, showing good application value. However, the preparation of organic aerogels involves too many organic reactions and is extremely sensitive to the control of conditions, so that the preparation is difficult and is limited to laboratory research, making it difficult to carry out large-scale production and application (N. Leventis, et al., Chem. Mater. 2011, 23, 2250). Therefore, the development of SiO₂ aerogels with both high strength and outstanding deformability has become an urgent need in the art.

### SUMMARY

An objective of the present invention is to provide an ultrahigh-strength SiO₂ aerogel with alternately configured soft chains and hard cores, and a method for preparing same, so as to solve problems such as low strength, high brittleness and poor processability of the conventional SiO₂ aerogels, low strength of the SiO₂ aerogels designed by structural engineering, as well as high brittleness of the existing high-strength SiO₂ aerogels and complexity of the preparation process.

In order to achieve the above objective, the present invention adopts the following technical solutions:

The present invention provides a method for preparing an ultrahigh-strength SiO₂ aerogel with alternately configured soft chains and hard cores, comprising the following steps:
(1) mixing octa-olefin functionalized silsesquioxane, a mercapto silane coupling agent and an organic solvent, adding a free radical polymerization initiator to perform an addition reaction, and then performing a vacuum drying treatment to obtain a white powder;
(2) mixing the white powder with an alcohol solution, and then performing a hydrolysis reaction and a heat-induced gelation reaction in sequence to obtain a gel; and
(3) subjecting the gel to aging, surface modification, displacement and vacuum lyophilization in sequence to obtain the ultrahigh-strength SiO₂ aerogel with alternately configured soft chains and hard cores.

Preferably, the octa-olefin functionalized silsesquioxane is octavinyl-polyhedral oligomeric silsesquioxane or acrylo-polyhedral oligomeric silsesquioxane; the mercapto silane coupling agent is one or more of 3-mercaptopropyltrimethoxysilane, 3-mercaptopropyltriethoxysilane, 3-mercaptopropylmethyldimethoxysilane and 3-mercaptopropylmethyldiethoxysilane; the organic solvent is one or more of diethyl ether, acetone, benzene and toluene; the molar ratio of the octa-olefin functionalized silsesquioxane to the mercapto silane coupling agent to the organic solvent is 1:(6-10):(8-12).

Preferably, in step (1), the mixing is performed under a protective gas, which is helium, argon, nitrogen or carbon dioxide; the mixing is performed at a temperature of 40-60° C.

Preferably, the free radical polymerization initiator is one or more of 2,2′-azobis(2-methylpropionitrile), 2,2′-azobis-(2,4-dimethylvaleronitrile), dibenzoyl peroxide and N,N-dimethylaniline; the molar ratio of the free radical polymerization initiator to the octa-olefin functionalized silsesquioxane is 1:(30-50); the addition reaction is performed at a temperature of 30-70° C. for a period of 8-12 h; the vacuum drying treatment is performed under a vacuum degree of 1-50 Pa at a temperature of 35-60° C. for a period of 4-8 h.

Preferably, the alcohol solution is a solution of an alcohol in water, wherein the alcohol is methanol, ethanol or isopropanol, and the volume ratio of the alcohol to the water in the alcohol solution is 1:(1-2); the mass-to-volume ratio of the white powder to the alcohol solution is 1 g:(2-4) mL.

Preferably, before the hydrolysis reaction, the pH value of a mixture obtained from the mixing is adjusted to 2-4; the hydrolysis reaction is performed at a temperature of 40-70° C. for a period of 2-4 h; before the heat-induced gelation reaction, the pH value of a product obtained from the hydrolysis reaction is adjusted to 8-10; the heat-induced gelation reaction is performed at a temperature of 60-80° ° C. for a period of 4-6 h.

Preferably, a reagent used for the aging is tert-butanol; the aging is performed at a temperature of 50-70° C. for a period of 24-48 h; a reagent used for the surface modification comprises a surface modifier and tert-butanol, wherein the surface modifier is trimethylsilyl chloride, trimethylmethoxysilane or bis(trimethylsilyl)amine, and the volume ratio of the surface modifier to the tert-butanol is 1:(2-4); the surface modification is performed 2-3 times, with each surface modification performed for a period of 4-6 h.

Preferably, a reagent used for the displacement is tert-butanol, wherein the volume of the tert-butanol used for the displacement is 6-12 times that of a wet gel obtained from the surface modification; the displacement is performed 3-5 times, with each displacement performed for a period of 8-12 h.

Preferably, the vacuum lyophilization is performed with an initial temperature of −30 to −10° C., a termination temperature of 45-70° C., a heating rate of 2-4° C./min, a heat preservation time of 6-10 h and a vacuum degree of 1-20 Pa.

The present invention further provides an ultrahigh-strength SiO₂ aerogel with alternately configured soft chains and hard cores, which is prepared by the method for preparing the ultrahigh-strength SiO₂ aerogel with alternately configured soft chains and hard cores.

It can be known from the above technical solutions that, as compared with the prior art, the present invention has the following beneficial effects:

(1) The present invention adopts an aerogel framework structure with alternately configured soft chains and hard cores, wherein the hard cores refer to hexahedral cage structures composed of Si—O—Si, and the soft chains refer to multi-link molecular chains. This structure ensures that the obtained ultrahigh-strength SiO₂ aerogel with alternately configured soft chains and hard cores not only has excellent compression deformability (an ultimate compression strain of 69.8%-84.3%), but also has ultrahigh strength (an ultimate compression strength of 12.54-30.26 MPa), which fundamentally overcomes a series of defects of existing SiO₂ aerogels, such as low strength, high brittleness and poor processability.

(2) With the structural advantages of the low-density (0.163-0.274 g/cm3), high-porosity (82.2%-92.1%) and communicated mesoporous-level (the average pore size is 32.59-68.55 nm) framework structure, and under the action of a large number of methyl and methylene groups that are inherently present or generated by modification, the ultrahigh-strength SiO₂ aerogel with alternately configured soft chains and hard cores obtained by the present invention has outstanding heat preservation and insulation performance and ultrastrong hydrophobicity, with a thermal conductivity as low as 0.026-0.035 W/(m·K) and a static water contact angle of up to 150.7-160.4°, thus having wide application prospects.

(3) The ultrahigh-strength SiO₂ aerogel with alternately configured soft chains and hard cores obtained by the present invention has excellent deformability, and there is no need to worry about the damage of a gel structure caused by volume change due to phase change of a solvent in the aerogel; moreover, the use of vacuum lyophilization method for drying can not only effectively avoid problems such as the excessive consumption of energy due to high-temperature supercritical conditions and the potential safety hazards in the process, but also avoid problems such as excessive emission of CO₂ gas due to low-temperature supercritical conditions, so that the present invention is more suitable for the background of the current double-carbon policy, in particular, easy to realize the large-scale production and application of SiO₂ aerogels. In addition, tert-butanol is selected as a reagent for displacement, so that the requirements of rapid vacuum lyophilization are met; because of the high freezing point of tert-butanol, solidification can occur at 23° C. or lower, such that the long-time freezing process before drying is avoided, and thus the preparation period of the SiO₂ aerogels is favorably shortened, which is extremely conducive to the promotion of industrialization and the large-scale application of the aerogels.

### BRIEF DESCRIPTION OF THE DRAWINGS

In order to more clearly illustrate the technical solution in the embodiments of the present invention or in the prior art, the drawings required to be used in the description of the embodiments or the prior art are briefly introduced below. It is obvious that the drawings in the description below are merely embodiments of the present invention, and those of ordinary skills in the art can obtain other drawings according to the drawings provided without creative efforts.

FIG. 1 shows an SEM image of an ultrahigh-strength SiO₂ aerogel with alternately configured soft chains and hard cores obtained in Example 1;

FIG. 2 shows a compression stress-strain curve of an ultrahigh-strength SiO₂ aerogel with alternately configured soft chains and hard cores obtained in Example 1;

FIG. 3 shows an SEM image of an ultrahigh-strength SiO₂ aerogel with alternately configured soft chains and hard cores obtained in Example 2;

FIG. 4 shows a compression stress-strain curve of an ultrahigh-strength SiO₂ aerogel with alternately configured soft chains and hard cores obtained in Example 2;

FIG. 5 shows an SEM image of an ultrahigh-strength SiO₂ aerogel with alternately configured soft chains and hard cores obtained in Example 3;

FIG. 6 shows a compression stress-strain curve of an ultrahigh-strength SiO₂ aerogel with alternately configured soft chains and hard cores obtained in Example 3;

FIG. 7 shows an SEM image of an ultrahigh-strength SiO₂ aerogel with alternately configured soft chains and hard cores obtained in Example 4;

FIG. 8 shows a compression stress-strain curve of an ultrahigh-strength SiO₂ aerogel with alternately configured soft chains and hard cores obtained in Example 4;

FIG. 9 shows an SEM image of an ultrahigh-strength SiO₂ aerogel with alternately configured soft chains and hard cores obtained in Example 5; and

FIG. 10 shows a compression stress-strain curve of an ultrahigh-strength SiO₂ aerogel with alternately configured soft chains and hard cores obtained in Example 5.

### DETAILED DESCRIPTION OF THE EMBODIMENTS

The present invention provides a method for preparing an ultrahigh-strength SiO₂ aerogel with alternately configured soft chains and hard cores, comprising the following steps:

(1) mixing octa-olefin functionalized silsesquioxane, a mercapto silane coupling agent and an organic solvent, and then adding a free radical polymerization initiator to perform an addition reaction and a vacuum drying treatment in sequence to obtain a white powder;

(2) mixing the white powder with an alcohol solution, and then performing a hydrolysis reaction and a heat-induced gelation reaction in sequence to obtain a gel; and

(3) subjecting the gel to aging, surface modification, displacement and vacuum lyophilization in sequence to obtain the ultrahigh-strength SiO₂ aerogel with alternately configured soft chains and hard cores.

In the present invention, the octa-olefin functionalized silsesquioxane is preferably octavinyl-polyhedral oligomeric silsesquioxane or acrylo-polyhedral oligomeric silsesquioxane, and further preferably acrylo-polyhedral oligomeric silsesquioxane; the mercapto silane coupling agent is preferably one or more of 3-mercaptopropyltrimethoxysilane, 3-mercaptopropyltriethoxysilane, 3-mercaptopropylmethyldimethoxysilane and 3-mercaptopropylmethyldiethoxysilane, and further preferably one or more of 3-mercaptopropyltrimethoxysilane, 3-mercaptopropyltriethoxysilane and 3-mercaptopropylmethyldimethoxysilane; the organic solvent is preferably one or more of diethyl ether, acetone, benzene and toluene, and further preferably diethyl ether and/or acetone; the molar ratio of the octa-olefin functionalized silsesquioxane to the mercapto silane coupling agent to the organic solvent is preferably 1:(6-10):(8-12), and further preferably 1:7-9:9-11.

In the present invention, in step (1), the mixing is performed under a protective gas, which is preferably helium, argon, nitrogen or carbon dioxide, and further preferably helium or nitrogen; the mixing is preferably performed at a temperature of 40-60° C., and further preferably 45-55° C.

In the present invention, the free radical polymerization initiator is preferably one or more of 2,2′-azobis(2-methylpropionitrile), 2,2′-azobis-(2,4-dimethylvaleronitrile), dibenzoyl peroxide and N,N-dimethylaniline, and further preferably 2,2′-azobis-(2,4-dimethylvaleronitrile) and/or dibenzoyl peroxide; the molar ratio of the free radical polymerization initiator to the octa-olefin functionalized silsesquioxane is preferably 1:(30-50), and further preferably 1:25-40; the addition reaction is preferably performed at a temperature of 30-70° C., and further preferably 40-60° C.; the addition reaction is preferably performed for a period of 8-12 h, and further preferably 9-11 h; the vacuum drying treatment is preferably performed at a temperature of 35-60° C., and further preferably 40-55° C.; the vacuum drying treatment is preferably performed under a vacuum degree of 1-50 Pa, and further preferably 5-20 Pa; the vacuum drying treatment is preferably performed for a period of 4-8 h, and further preferably 6-7 h.

In the present invention, the alcohol solution is preferably a solution of an alcohol in water; the alcohol is preferably methanol, ethanol or isopropanol, and further preferably methanol or isopropanol; the volume ratio of the alcohol to the water in the alcohol solution is preferably 1:(1-2), and further preferably 1:1.2-1.8; the mass-to-volume ratio of the white powder to the alcohol solution is preferably 1 g:(2-4) mL, and further preferably 1 g:2.5-3.5 mL.

In the present invention, before the hydrolysis reaction, the pH value of a mixture obtained from the mixing is preferably adjusted to 2-4, and further preferably adjusted to 2.5-3.5; the hydrolysis reaction is preferably performed at a temperature of 40-70° C., and further preferably 45-65° C.; the hydrolysis reaction is preferably performed for a period of 2-4 h, and further preferably 2.5-3.5 h; before the heat-induced gelation reaction, the pH value of a product obtained from the hydrolysis reaction is preferably adjusted to 8-10, and further preferably adjusted to 8.5-9; the heat-induced gelation reaction is preferably performed at a temperature of 60-80° C., and further preferably 65-75° C.; the heat-induced gelation reaction is preferably performed for a period of 4-7 h, and further preferably 5-6 h.

In the present invention, a reagent for adjusting the pH value of the mixture obtained from the mixing is preferably hydrochloric acid or sulfuric acid, and further preferably hydrochloric acid; the mass fraction of the hydrochloric acid is preferably 40%-60%, and further preferably 45%-55%; the mass fraction of the sulfuric acid is preferably 30%-50%, and further preferably 35%-40%; a reagent for adjusting the pH value of the product obtained from the hydrolysis reaction is preferably potassium hydroxide or sodium hydroxide, and further preferably potassium hydroxide.

In the present invention, a reagent used for the aging is preferably tert-butanol; a reagent used for the surface modification preferably comprises a surface modifier and tert-butanol, wherein the surface modifier is preferably trimethylsilyl chloride, trimethylmethoxysilane or bis(trimethylsilyl)amine, and further preferably trimethylmethoxysilane or bis(trimethylsilyl)amine; the volume ratio of the surface modifier to the tert-butanol is preferably 1:(2-4), and further preferably 1:2.5-3.8; a reagent used for the displacement is preferably tert-butanol, wherein the volume of the tert-butanol used for the displacement is preferably 6-12 times that of a wet gel obtained from the surface modification, and further preferably 7-11 times that of a wet gel obtained from the surface modification.

In the present invention, the tert-butanol used for the aging, the tert-butanol used for the surface modification and the tert-butanol used for the displacement are preferably tert-butanol solutions; the mass fraction of the tert-butanol solutions is preferably 96%-98%, and further preferably 97%-97.5%.

In the present invention, the aging is preferably performed at a temperature of 50-70° C., and further preferably 55-65° C.; the aging is preferably performed for a period of 24-48 h, and further preferably 25-44 h; the surface modification is preferably performed 2-3 times, and further preferably 3 times; each surface modification is preferably performed for a period of 4-6 h, and further preferably 4.5-5 h; the displacement is preferably performed 3-5 times, and further preferably 4 times; each displacement is preferably performed for a period of 8-12 h, and further preferably 9-11 h.

In the present invention, the vacuum lyophilization adopts a programmed temperature rise control mode; the vacuum lyophilization is preferably performed with an initial temperature of −30 to −10° C., and further preferably −25 to −15° C.; the vacuum lyophilization is preferably performed with a termination temperature of 45-70° C., and further preferably 50-65° C.; the vacuum lyophilization is preferably performed with a heating rate of 2-4° C./min, and further preferably 2.5-3.5° C./min; the vacuum lyophilization is preferably performed with a heat preservation time of 6-10 h, and further preferably 7-9 h; the vacuum lyophilization is preferably performed under a vacuum degree of 1-20 Pa, and further preferably 5-10 Pa.

According to the present invention, firstly, octa-olefin functionalized silsesquioxane and a mercapto silane coupling agent are dissolved in an organic solvent under a protective gas, a free radical polymerization initiator is added to the mixture to perform a catalytic reaction at a certain temperature for a period of time, and then the reaction system is dried to obtain a white powder; secondly, the white powder is dissolved in an alcohol solution, the mixture is stirred until the white powder is completely dissolved, and then a heat-induced sol-gel reaction is performed to obtain a SiO₂ wet gel; and finally, the gel is subjected to aging, surface modification, and vacuum lyophilization with a programmed temperature rise mode to obtain the ultrahigh-strength SiO₂ aerogel with alternately configured soft chains and hard cores.

The present invention further provides an ultrahigh-strength SiO₂ aerogel with alternately configured soft chains and hard cores, which is prepared by the method for preparing the ultrahigh-strength SiO₂ aerogel with alternately configured soft chains and hard cores.

The present invention abandons the conventional approach of preparing SiO₂ aerogels from various silicone greases, and adopts the design concept of an aerogel framework structure with alternately configured soft chains and hard cores, wherein the hard cores refer to hexahedral cage structures composed of Si—O—Si, and the soft chains refer to multi-link molecular chains. Thanks to this special structural design, the deformation of the obtained ultrahigh-strength SiO₂ aerogel with alternately configured soft chains and hard cores under low compression strain is microscopically reflected as the bending of the multi-link molecular chains, so that only a small force is required to make the ultrahigh-strength SiO₂ aerogel undergo a large deformation. Under high compression strain, the hexahedral cores composed of Si—O—Si microscopically start to generate interactions such as accumulation, extrusion or repulsion in the compression direction, effectively enhancing the compression strength.

The technical solutions provided by the present invention will be described in detail below with reference to the examples, which, however, should not be construed as limiting the protection scope of the present invention.

### Example 1

Step 1: acrylo-polyhedral oligomeric silsesquioxane, 3-mercaptopropyltriethoxysilane and diethyl ether were added into a three-necked flask in a molar ratio of 1:8:12; helium was introduced into the flask as a protective gas, and then the mixture was stirred at 50° C. until complete dissolution was achieved.

Step 2: dibenzoyl peroxide (the molar ratio of dibenzoyl peroxide to the acrylo-polyhedral oligomeric silsesquioxane was 1:40) was added into the dissolution system of step 1; the mixture was stirred and allowed to react at 50° C. for 12 h, and then a vacuum drying treatment was performed on the solution obtained from the reaction at 40° C. under a vacuum degree of 30 Pa for 8 h to obtain a white powder.

Step 3: 3 g of the white powder was added into 6 mL of an aqueous methanol solution with a methanol-water volume ratio of 1:1, and the mixture was stirred until the white powder was completely dissolved; the pH value of the reaction system was then adjusted to 3 by using hydrochloric acid with a mass fraction of 40%, and a hydrolysis reaction was performed at 60° C. for 3 h.

Step 4: after the pH value of the reaction solution obtained in step 3 was adjusted to 9 by using potassium hydroxide, stirring was immediately stopped, and the solution was placed in a hydrothermal reactor and subjected to a heat-induced gelation reaction at 70° C. for 5 h to obtain a SiO₂ wet gel.

Step 5: the SiO₂ wet gel obtained in step 4 was placed in a tert-butanol solution with a mass fraction of 96%, and after aging at 60° C. for 36 h, the SiO₂ wet gel was placed in a tert-butanol solution of trimethylmethoxysilane (the volume ratio of the trimethylmethoxysilane to the tert-butanol solution was 1:3, and the mass fraction of the tert-butanol solution was 96%) to perform surface modification for 4 h, and the surface modification was repeated 3 times.

Step 6: the product obtained in step 5 was placed in a tert-butanol solution with a volume of 12 times that of the product and a mass fraction of 96% to perform displacement for 12 h, and the displacement was repeated 3 times.

Step 7: vacuum lyophilization was performed on the SiO₂ alcohol gel obtained in step 6 under a vacuum degree of 20 Pa, with an initial temperature of −20° C., a heating rate of 4 ºC/min and a termination temperature of 60° C., and lasted for a period of 8 h, so as to obtain the ultrahigh-strength SiO₂ aerogel with alternately configured soft chains and hard cores.

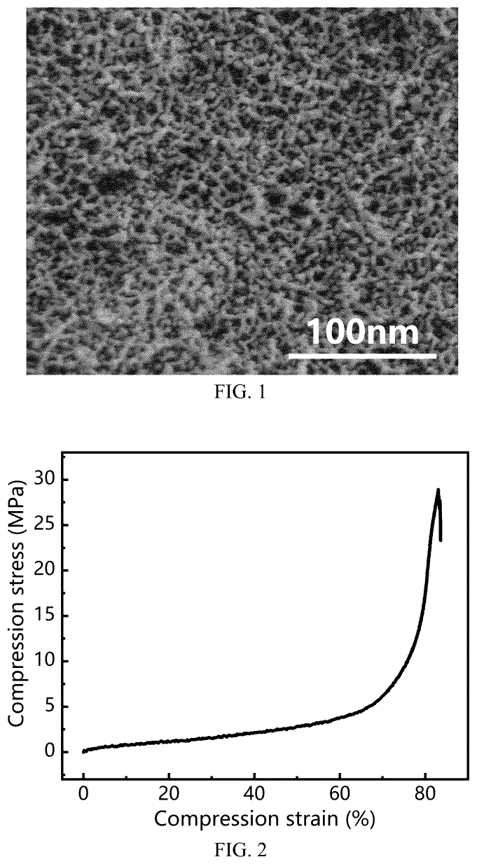

The surface morphology and performance of the ultrahigh-strength SiO₂ aerogel with alternately configured soft chains and hard cores obtained in this example were tested, and the results obtained are shown in FIG. 1 and FIG. 2. As can be seen from FIG. 1 and FIG. 2, the ultrahigh-strength SiO₂ aerogel with alternately configured soft chains and hard cores obtained in this example has a three-dimensional nanoporous framework structure, with a density of 0.263 g/cm3, a porosity of 84.1% and an average pore size of 38.85 nm; the ultrahigh-strength SiO₂ aerogel with alternately configured soft chains and hard cores obtained in this example has an ultimate compression strength of 28.94 MPa, an ultimate compression strain of 83.6%, a thermal conductivity of 0.03173 W/(m·K) and a static water contact angle of 151.4°.

### Example 2

Step 1: octavinyl-polyhedral oligomeric silsesquioxane, 3-mercaptopropylmethyldiethoxysilane and acetone were added into a three-necked flask in a molar ratio of 1:7:8; argon was introduced into the flask as a protective gas, and then the mixture was stirred at 40° C. until complete dissolution was achieved.

Step 2: 2,2′-azobis-(2,4-dimethylvaleronitrile) (the molar ratio of 2,2′-azobis-(2,4-dimethylvaleronitrile) to the octavinyl-polyhedral oligomeric silsesquioxane was 1:30) was added into the dissolution system of step 1; the mixture was stirred and allowed to react at 70° ° C. for 10 h, and then a vacuum drying treatment was performed on the solution obtained from the reaction at 50° C. under a vacuum degree of 1 Pa for 4 h to obtain a white powder.

Step 3: 3 g of the white powder was added into 8 mL of an aqueous ethanol solution with an ethanol-water volume ratio of 1:1.5, and the mixture was stirred until the white powder was completely dissolved; the pH value of the reaction system was then adjusted to 2 by using hydrochloric acid with a mass fraction of 45%, and a hydrolysis reaction was performed at 70° C. for 2 h.

Step 4: after the pH value of the reaction solution obtained in step 3 was adjusted to 8 by using potassium hydroxide, stirring was immediately stopped, and the solution was placed in a hydrothermal reactor and subjected to a heat-induced gelation reaction at 80° C. for 4 h to obtain a SiO₂ wet gel.

Step 5: the SiO₂ wet gel obtained in step 4 was placed in a tert-butanol solution with a mass fraction of 97%, and after aging at 50° C. for 48 h, the SiO₂ wet gel was placed in a tert-butanol solution of trimethylsilyl chloride (the volume ratio of the trimethylsilyl chloride to the tert-butanol solution was 1:2, and the mass fraction of the tert-butanol solution was 97%) to perform surface modification for 6 h, and the surface modification was repeated 2 times.

Step 6: the product obtained in step 5 was placed in a tert-butanol solution with a volume of 10 times that of the product and a mass fraction of 97% to perform displacement for 10 h, and the displacement was repeated 4 times.

Step 7: vacuum lyophilization was performed on the SiO₂ alcohol gel obtained in step 6 under a vacuum degree of 1 Pa, with an initial temperature of −30° C., a heating rate of 3° C./min and a termination temperature of 45° C., and lasted for a period of 10 h, so as to obtain the ultrahigh-strength SiO₂ aerogel with alternately configured soft chains and hard cores.

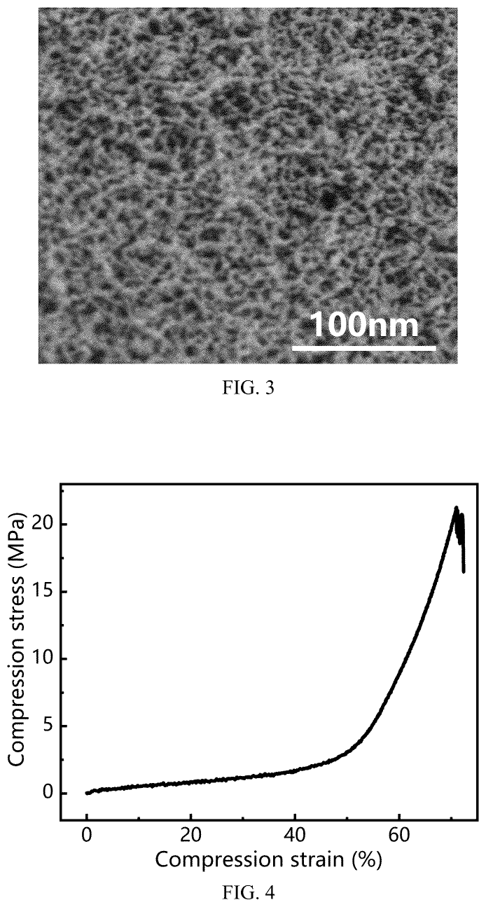

The surface morphology and performance of the ultrahigh-strength SiO₂ aerogel with alternately configured soft chains and hard cores obtained in this example were tested, and the results obtained are shown in FIG. 3 and FIG. 4. As can be seen from FIG. 3 and FIG. 4, the ultrahigh-strength SiO₂ aerogel with alternately configured soft chains and hard cores obtained in this example has a three-dimensional nanoporous framework structure, with a density of 0.234 g/cm3, a porosity of 87.6% and an average pore size of 41.35 nm; the ultrahigh-strength SiO₂ aerogel with alternately configured soft chains and hard cores obtained in this example has an ultimate compression strength of 21.26 MPa, an ultimate compression strain of 72.4%, a thermal conductivity of 0.02889 W/(m·K) and a static water contact angle of 158.6°.

### Example 3

Step 1: acrylo-polyhedral oligomeric silsesquioxane, 3-mercaptopropyltrimethoxysilane and benzene were added into a three-necked flask in a molar ratio of 1:6:10; carbon dioxide was introduced into the flask as a protective gas, and then the mixture was stirred at 60° ° C. until complete dissolution was achieved.

Step 2: 2,2′-azobis(2-methylpropionitrile) (the molar ratio of 2,2′-azobis(2-methylpropionitrile) to the acrylo-polyhedral oligomeric silsesquioxane was 1:45) was added into the dissolution system of step 1; the mixture was stirred and allowed to react at 30° C. for 9 h, and then a vacuum drying treatment was performed on the solution obtained from the reaction at 55° C. under a vacuum degree of 50 Pa for 8 h to obtain a white powder.

Step 3: 3 g of the white powder was added into 12 mL of an aqueous isopropanol solution with an isopropanol-water volume ratio of 1:1, and the mixture was stirred until the white powder was completely dissolved; the pH value of the reaction system was then adjusted to 4 by using hydrochloric acid with a mass fraction of 50%, and a hydrolysis reaction was performed at 65° C. for 3 h.

Step 4: after the pH value of the reaction solution obtained in step 3 was adjusted to 9.5 by using potassium hydroxide, stirring was immediately stopped, and the solution was placed in a hydrothermal reactor and subjected to a heat-induced gelation reaction at 75° C. for 5 h to obtain a SiO₂ wet gel.

Step 5: the SiO₂ wet gel obtained in step 4 was placed in a tert-butanol solution with a mass fraction of 96%, and after aging at 70° C. for 30 h, the SiO₂ wet gel was placed in a tert-butanol solution of bis(trimethylsilyl)amine (the volume ratio of the bis(trimethylsilyl)amine to the tert-butanol solution was 1:3, and the mass fraction of the tert-butanol solution was 96%) to perform surface modification for 4 h, and the surface modification was repeated 2 times.

Step 6: the product obtained in step 5 was placed in a tert-butanol solution with a volume of 6 times that of the product and a mass fraction of 96% to perform displacement for 8 h, and the displacement was repeated 5 times.

Step 7: vacuum lyophilization on the SiO₂ alcohol gel obtained in step 6 was performed under a vacuum degree of 15 Pa, with an initial temperature of −10° C., a heating rate of 2° C./min and a termination temperature of 70° C., and lasted for a period of 6 h, so as to obtain the ultrahigh-strength SiO₂ aerogel with alternately configured soft chains and hard cores.

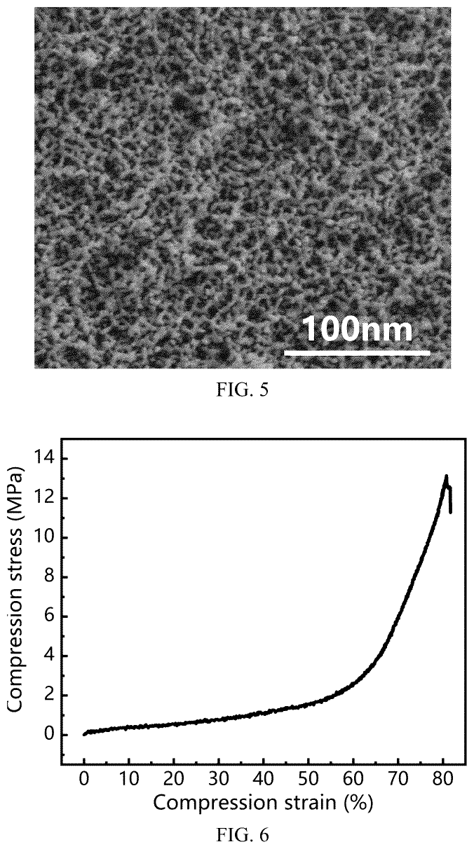

The surface morphology and performance of the ultrahigh-strength SiO₂ aerogel with alternately configured soft chains and hard cores obtained in this example were tested, and the results obtained are shown in FIG. 5 and FIG. 6. As can be seen from FIG. 5 and FIG. 6, the ultrahigh-strength SiO₂ aerogel with alternately configured soft chains and hard cores obtained in this example has a three-dimensional nanoporous framework structure, with a density of 0.171 g/cm3, a porosity of 91.2% and an average pore size of 61.23 nm; the ultrahigh-strength SiO₂ aerogel with alternately configured soft chains and hard cores obtained in this example has an ultimate compression strength of 13.16 MPa, an ultimate compression strain of 81.7%, a thermal conductivity of 0.03032 W/(m·K) and a static water contact angle of 151.2°.

### Example 4

Step 1: octavinyl-polyhedral oligomeric silsesquioxane, 3-mercaptopropyltriethoxysilane and toluene were added into a three-necked flask in a molar ratio of 1:9:11; nitrogen was introduced into the flask as a protective gas, and then the mixture was stirred at 50° C. until complete dissolution was achieved.

Step 2: N,N-dimethylaniline (the molar ratio of N,N-dimethylaniline to the octavinyl-polyhedral oligomeric silsesquioxane was 1:35) was added into the dissolution system of step 1; the mixture was stirred and allowed to react at 55° C. for 11 h, and then a vacuum drying treatment was performed on the solution obtained from the reaction at 45° C. under a vacuum degree of 10 Pa for 7 h to obtain a white powder.

Step 3: 3 g of the white powder was added into 9 mL of an aqueous ethanol solution with an ethanol-water volume ratio of 1:1.2, and the mixture was stirred until the white powder was completely dissolved; the pH value of the reaction system was then adjusted to 3.5 by using sulfuric acid with a mass fraction of 30%, and a hydrolysis reaction was performed at 45° C. for 4 h.

Step 4: after the pH value of the reaction solution obtained in step 3 was adjusted to 10 by using potassium hydroxide, stirring was immediately stopped, and the solution was placed in a hydrothermal reactor and subjected to a heat-induced gelation reaction at 65° C. for 6 h to obtain a SiO₂ wet gel.

Step 5: the SiO₂ wet gel obtained in step 4 was placed in a tert-butanol solution with a mass fraction of 96%, and after aging at 50° C. for 45 h, the SiO₂ wet gel was placed in a tert-butanol solution of trimethylsilyl chloride (the volume ratio of the trimethylsilyl chloride to the tert-butanol solution was 1:4, and the mass fraction of the tert-butanol solution was 96%) to perform surface modification for 5 h, and the surface modification was repeated 3 times.

Step 6: the product obtained in step 5 was placed in a tert-butanol solution with a volume of 12 times that of the product and a mass fraction of 96% to perform displacement for 10 h, and the displacement was repeated 4 times.

Step 7: vacuum lyophilization was performed on the SiO₂ alcohol gel obtained in step 6 under a vacuum degree of 5 Pa, with an initial temperature of −15° C., a heating rate of 3 ºC/min and a termination temperature of 60° C., and lasted for a period of 10 h, so as to obtain the ultrahigh-strength SiO₂ aerogel with alternately configured soft chains and hard cores.

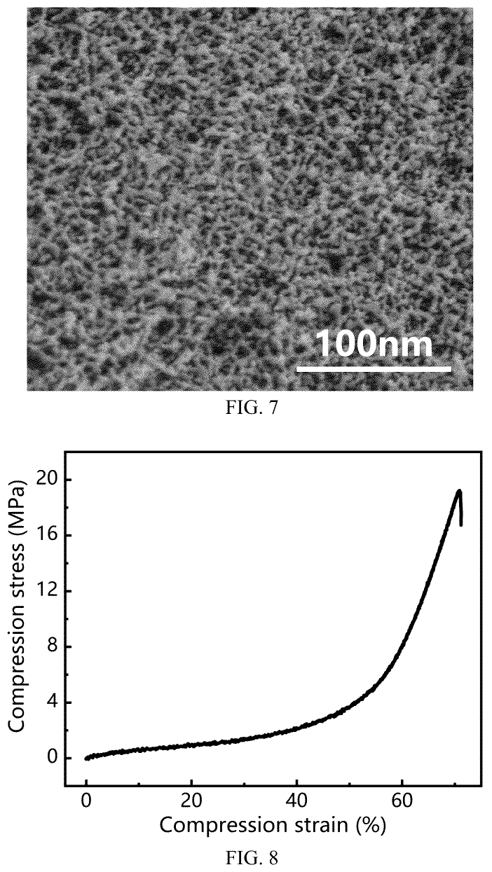

The surface morphology and performance of the ultrahigh-strength SiO₂ aerogel with alternately configured soft chains and hard cores obtained in this example were tested, and the results obtained are shown in FIG. 7 and FIG. 8. As can be seen from FIG. 7 and FIG. 8, the ultrahigh-strength SiO₂ aerogel with alternately configured soft chains and hard cores obtained in this example has a three-dimensional nanoporous framework structure, with a density of 0.217 g/cm3, a porosity of 89.1% and an average pore size of 42.91 nm; the ultrahigh-strength SiO₂ aerogel with alternately configured soft chains and hard cores obtained in this example has an ultimate compression strength of 19.18 MPa, an ultimate compression strain of 71.2%, a thermal conductivity of 0.02723 W/(m·K) and a static water contact angle of 153.3º.

### Example 5

Step 1: acrylo-polyhedral oligomeric silsesquioxane, 3-mercaptopropyltrimethoxysilane and diethyl ether were added into a three-necked flask in a molar ratio of 1:10:8; carbon dioxide was introduced into the flask as a protective gas, and then the mixture was stirred at 55° C. until complete dissolution was achieved.

Step 2: 2,2′-azobis-(2,4-dimethylvaleronitrile) (the molar ratio of 2,2′-azobis-(2,4-dimethylvaleronitrile) to the acrylo-polyhedral oligomeric silsesquioxane was 1:30) was added into the dissolution system of step 1; the mixture was stirred and allowed to react at 40° C. for 12 h, and then a vacuum drying treatment was performed on the solution obtained from the reaction at 50° C. under a vacuum degree of 5 Pa for 6 h to obtain a white powder.

Step 3: 3 g of the white powder was added into 10 mL of an aqueous methanol solution with a methanol-water volume ratio of 1:1.4, and the mixture was stirred until the white powder was completely dissolved; the pH value of the reaction system was then adjusted to 2.5 by using hydrochloric acid with a mass fraction of 50%, and a hydrolysis reaction was performed at 50° C. for 4 h.

Step 4: after the pH value of the reaction solution obtained in step 3 was adjusted to 9 by using potassium hydroxide, stirring was immediately stopped, and the solution was placed in a hydrothermal reactor and subjected to a heat-induced gelation reaction at 75° C. for 5 h to obtain a SiO₂ wet gel.

Step 5: the SiO₂ wet gel obtained in step 4 was placed in a tert-butanol solution with a mass fraction of 97%, and after aging at 65° C. for 25 h, the SiO₂ wet gel was placed in a tert-butanol solution of trimethylmethoxysilane (the volume ratio of the trimethylmethoxysilane to the tert-butanol solution was 1:2, and the mass fraction of the tert-butanol solution was 97%) to perform surface modification for 6 h, and the surface modification was repeated 2 times.

Step 6: the product obtained in step 5 was placed in a tert-butanol solution with a volume of 10 times that of the product and a mass fraction of 97% to perform displacement for 8 h, and the displacement was repeated 5 times.

Step 7: vacuum lyophilization was performed on the SiO₂ alcohol gel obtained in step 6 under a vacuum degree of 15 Pa, with an initial temperature of −25° C., a heating rate of 4° C./min and a termination temperature of 50° C., and lasted for a period of 9 h, so as to obtain the ultrahigh-strength SiO₂ aerogel with alternately configured soft chains and hard cores.

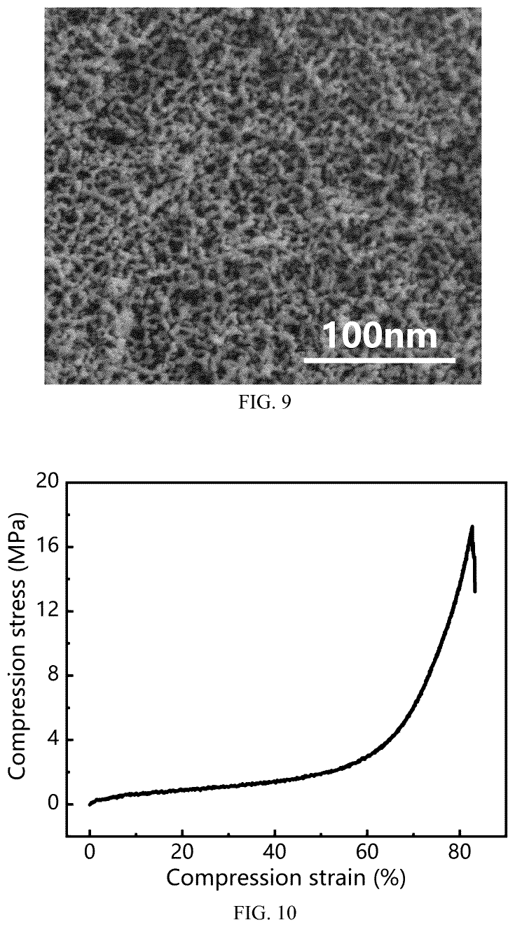

The surface morphology and performance of the ultrahigh-strength SiO₂ aerogel with alternately configured soft chains and hard cores obtained in this example were tested, and the results obtained are shown in FIG. 9 and FIG. 10. As can be seen from FIG. 9 and FIG. 10, the ultrahigh-strength SiO₂ aerogel with alternately configured soft chains and hard cores obtained in this example has a three-dimensional nanoporous framework structure, with a density of 0.211 g/cm3, a porosity of 89.4% and an average pore size of 52.14 nm; the ultrahigh-strength SiO₂ aerogel with alternately configured soft chains and hard cores obtained in this example has an ultimate compression strength of 17.27 MPa, an ultimate compression strain of 83.2%, a thermal conductivity of 0.02837 W/(m·K) and a static water contact angle of 150.7°.

### Example 6

This Example differs from Example 1 in that the acrylo-polyhedral oligomeric silsesquioxane was replaced with octavinyl-polyhedral oligomeric silsesquioxane; the remaining procedures were the same as those in Example 1.

### Example 7

This Example differs from Example 3 in that the acrylo-polyhedral oligomeric silsesquioxane was replaced with octavinyl-polyhedral oligomeric silsesquioxane; the remaining procedures were the same as those in Example 3.

### Example 8

This Example differs from Example 5 in that the acrylo-polyhedral oligomeric silsesquioxane was replaced with octavinyl-polyhedral oligomeric silsesquioxane; the remaining procedures were the same as those in Example 5.

### Example 9

This Example differs from Example 2 in that the octavinyl-polyhedral oligomeric silsesquioxane was replaced with acrylo-polyhedral oligomeric silsesquioxane; the remaining procedures were the same as those in Example 2.

### Example 10

This Example differs from Example 4 in that the octavinyl-polyhedral oligomeric silsesquioxane was replaced with acrylo-polyhedral oligomeric silsesquioxane; the remaining procedures were the same as those in Example 4.

### Example 11

This Example differs from Example 3 in that the 3-mercaptopropyltrimethoxysilane was replaced with 3-mercaptopropylmethyldimethoxysilane; the remaining procedures were the same as those in Example 3.

### Example 12

This Example differs from Example 5 in that the 3-mercaptopropyltrimethoxysilane was replaced with 3-mercaptopropylmethyldimethoxysilane; the remaining procedures were the same as those in Example 5.

### Example 13

This Example differs from Example 1 in that the molar ratio of acrylo-polyhedral oligomeric silsesquioxane to 3-mercaptopropyltriethoxysilane to diethyl ether was 1:8:8; the remaining procedures were the same as those in Example 1.

### Example 14

This Example differs from Example 4 in that the molar ratio of octavinyl-polyhedral oligomeric silsesquioxane to 3-mercaptopropyltriethoxysilane to toluene was 1:8:8; the remaining procedures were the same as those in Example 4.

### Example 15

This Example differs from Example 1 in that the free radical polymerization initiator was 2,2′-azobis(2-methylpropionitrile) and the molar ratio of 2,2′-azobis(2-methylpropionitrile) to octa-olefin functionalized silsesquioxane was controlled at 1:30; the remaining procedures were the same as those in Example 1.

### Example 16

This Example differs from Example 2 in that the free radical polymerization initiator was 2,2′-azobis(2-methylpropionitrile) and the molar ratio of 2,2′-azobis(2-methylpropionitrile) to octa-olefin functionalized silsesquioxane was controlled at 1:30; the remaining procedures were the same as those in Example 2.

### Example 17

This Example differs from Example 3 in that in step 3, 3 g of white powder was added into 9 mL of an aqueous ethanol solution with an ethanol-water volume ratio of 1:1.6; the remaining procedures were the same as those in Example 3.

### Example 18

This Example differs from Example 4 in that in step 3, 3 g of white powder was added into 9 mL of an aqueous ethanol solution with an ethanol-water volume ratio of 1:1.6; the remaining procedures were the same as those in Example 4.

### Example 19

This Example differs from Example 4 in that in step 5, a tert-butanol solution of bis(trimethylsilyl)amine (the volume ratio of the bis(trimethylsilyl)amine to the tert-butanol solution was 1:2) was used for surface modification for 5 h, and the surface modification was repeated 3 times; the remaining procedures were the same as those in Example 4.

### Example 20

This Example differs from Example 5 in that in step 5, a tert-butanol solution of bis(trimethylsilyl)amine (the volume ratio of the bis(trimethylsilyl)amine to the tert-butanol solution was 1:2) was used for surface modification for 5 h, and the surface modification was repeated 3 times; the remaining procedures were the same as those in Example 5.

The structure and performance of the ultrahigh-strength SiO₂ aerogels with alternately configured soft chains and hard cores obtained in Examples 1-20 were tested, and the test results are shown in Table 1.

TABLE 1
Structural parameters and performance characterization results
of ultrahigh-strength SiO₂ aerogels of various examples

| | | | | Ultimate | | | Water |
|---|---|---|---|---|---|---|---|
| | | | Average | compression | Breaking | Thermal | contact |
| | Density | Porosity | pore size | strength | strain | conductivity | angle |
| Example | (g/cm³) | (%) | (nm) | (MPa) | (%) | [W/(m · K)] | (°) |
| Example 1 | 0.263 | 84.1 | 38.85 | 28.94 | 83.6 | 0.03173 | 151.4 |
| Example 2 | 0.234 | 87.6 | 41.35 | 21.26 | 72.4 | 0.02889 | 158.6 |
| Example 3 | 0.171 | 91.2 | 61.23 | 13.16 | 81.7 | 0.03032 | 151.2 |
| Example 4 | 0.217 | 89.1 | 42.91 | 19.18 | 71.2 | 0.02723 | 153.3 |
| Example 5 | 0.211 | 89.4 | 52.14 | 17.27 | 83.2 | 0.02837 | 150.7 |
| Example 6 | 0.274 | 82.2 | 32.59 | 30.26 | 71.0 | 0.03144 | 152.1 |
| Example 7 | 0.189 | 90.3 | 54.64 | 14.85 | 69.8 | 0.02764 | 151.2 |
| Example 8 | 0.221 | 88.7 | 47.68 | 18.91 | 70.6 | 0.02892 | 151.9 |
| Example 9 | 0.227 | 88.5 | 48.63 | 20.71 | 84.3 | 0.02974 | 160.4 |
| Example 10 | 0.201 | 90.0 | 53.46 | 17.88 | 82.6 | 0.03044 | 152.7 |
| Example 11 | 0.163 | 92.1 | 68.55 | 12.54 | 82.6 | 0.03453 | 159.3 |
| Example 12 | 0.203 | 89.9 | 59.41 | 16.58 | 84.1 | 0.03145 | 158.7 |
| Example 13 | 0.259 | 84.5 | 38.74 | 29.16 | 82.7 | 0.03112 | 152.6 |
| Example 14 | 0.222 | 88.4 | 41.15 | 19.86 | 71.0 | 0.02695 | 151.2 |
| Example 15 | 0.255 | 84.7 | 38.02 | 27.71 | 83.1 | 0.03078 | 152.0 |
| Example 16 | 0.235 | 87.7 | 40.83 | 22.12 | 73.1 | 0.02914 | 157.9 |
| Example 17 | 0.209 | 89.6 | 44.13 | 17.89 | 82.9 | 0.02855 | 151.7 |
| Example 18 | 0.215 | 89.3 | 43.02 | 19.01 | 71.8 | 0.02785 | 153.7 |
| Example 19 | 0.211 | 89.6 | 43.26 | 18.99 | 72.4 | 0.02825 | 152.1 |
| Example 20 | 0.213 | 88.9 | 53.01 | 18.54 | 84.3 | 0.02884 | 151.6 |

As can be seen from Table 1, the ultrahigh-strength SiO₂ aerogel with alternately configured soft chains and hard cores obtained by the present invention not only has excellent compression deformability, but also has ultrahigh strength, with an ultimate compression strain of 69.8%-84.3% and an ultimate compression strength of 12.54-30.26 MPa. Moreover, the ultrahigh-strength SiO₂ aerogel with alternately configured soft chains and hard cores obtained by the present invention has a communicated mesoporous-level (the average pore size is 32.59-68.55 nm) framework structure with low density (0.163-0.274 g/cm3) and high porosity (82.2%-92.1%), and therefore, has outstanding heat preservation and insulation performance and ultrastrong hydrophobicity, with a thermal conductivity as low as 0.026-0.035 W/(m·K) and a static water contact angle of up to 150.7-160.4°.

The above descriptions are only preferred embodiments of the present invention. It should be noted that those of ordinary skill in the art can also make several improvements and modifications without departing from the principle of the present invention, and such improvements and modifications shall fall within the protection scope of the present invention.

What is claimed is:

1. A method for preparing an ultrahigh-strength SiO₂ aerogel with alternately configured soft chains and hard cores, comprising the following steps:
(1) mixing octa-olefin functionalized silsesquioxane, a mercapto silane coupling agent, and an organic solvent to obtain a first resulting mixture, adding a free radical polymerization initiator to the first resulting mixture to perform an addition reaction, and then performing a vacuum drying treatment to obtain a white powder;
(2) mixing the white powder with an alcohol solution to obtain a second resulting mixture, and then performing a hydrolysis reaction and a heat-induced gelation reaction in sequence to obtain a gel; and
(3) subjecting the gel to aging, surface modification, displacement, and vacuum lyophilization in sequence to obtain the ultrahigh-strength SiO₂ aerogel with the alternately configured soft chains and hard cores;
wherein
a reagent used for the aging is tert-butanol; the aging is performed at a temperature of 50-70° C. for a period of 24-48 h; a reagent used for the surface modification comprises a surface modifier and tert-butanol, wherein the surface modifier is trimethylsilyl chloride, trimethylmethoxysilane, or bis(trimethylsilyl)amine, and a volume ratio of the surface modifier to the tert-butanol is 1:(2-4); the surface modification is performed 2-3 times, with each surface modification performed for a period of 4-6 h;
a reagent used for the displacement is tert-butanol, wherein a volume of the tert-butanol used for the displacement is 6-12 times a volume of a wet gel obtained from the surface modification; the displacement is performed 3-5 times, with each displacement performed for a period of 8-12 h;
the vacuum lyophilization is performed with an initial temperature of −30 to −10° C., a termination temperature of 45-70° C., a heating rate of 2-4° C./min, a heat preservation time of 6-10 h, and a vacuum degree of 1-20 Pa.

2. The method for preparing the ultrahigh-strength SiO₂ aerogel with the alternately configured soft chains and hard cores according to claim 1, wherein the octa-olefin functionalized silsesquioxane is octavinyl-polyhedral oligomeric silsesquioxane or acrylo-polyhedral oligomeric silsesquioxane; the mercapto silane coupling agent is one or more of 3-mercaptopropyltrimethoxysilane, 3-mercaptopropyltriethoxysilane, 3-mercaptopropylmethyldimethoxysilane, and 3-mercaptopropylmethyldiethoxysilane; the organic solvent is one or more of diethyl ether, acetone, benzene, and toluene; a molar ratio of the octa-olefin functionalized silsesquioxane to the mercapto silane coupling agent to the organic solvent is 1:(6-10):(8-12).

3. The method for preparing the ultrahigh-strength SiO₂ aerogel with the alternately configured soft chains and hard cores according to claim 2, wherein in step (1), the mixing is performed under a protective gas, and the protective gas is helium, argon, nitrogen, or carbon dioxide; the mixing is performed at a temperature of 40-60° C.

4. The method for preparing the ultrahigh-strength SiO₂ aerogel with the alternately configured soft chains and hard cores according to claim 1, wherein the free radical polymerization initiator is one or more of 2,2′-azobis(2-methylpropionitrile), 2,2′-azobis-(2,4-dimethylvaleronitrile), dibenzoyl peroxide, and N,N-dimethylaniline; a molar ratio of the free radical polymerization initiator to the octa-olefin functionalized silsesquioxane is 1:(30-50); the addition reaction is performed at a temperature of 30-70° C. for a period of 8-12 h; the vacuum drying treatment is performed under a vacuum degree of 1-50 Pa at a temperature of 35-60° C. for a period of 4-8 h.

5. The method for preparing the ultrahigh-strength SiO₂ aerogel with the alternately configured soft chains and hard cores according to claim 4, wherein the alcohol solution is a solution of an alcohol in water, wherein the alcohol is methanol, ethanol, or isopropanol, and a volume ratio of the alcohol to the water in the alcohol solution is 1:(1-2); a mass-to-volume ratio of the white powder to the alcohol solution is 1 g:(2-4) mL.

6. The method for preparing the ultrahigh-strength SiO₂ aerogel with the alternately configured soft chains and hard cores according to claim 1, wherein before the hydrolysis reaction, a pH value of the second resulting mixture is adjusted to 2-4; the hydrolysis reaction is performed at a temperature of 40-70° C. for a period of 2-4 h; before the heat-induced gelation reaction, a pH value of a product obtained from the hydrolysis reaction is adjusted to 8-10; the heat-induced gelation reaction is performed at a temperature of 60-80° ° C. for a period of 4-6 h.

7. An ultrahigh-strength SiO₂ aerogel with alternately configured soft chains and hard cores, prepared by the method for preparing the ultrahigh-strength SiO₂ aerogel with the alternately configured soft chains and hard cores according to claim 1.

8. The method for preparing the ultrahigh-strength SiO₂ aerogel with the alternately configured soft chains and hard cores according to claim 2, wherein the free radical polymerization initiator is one or more of 2,2′-azobis(2-methylpropionitrile), 2,2′-azobis-(2,4-dimethylvaleronitrile), dibenzoyl peroxide, and N,N-dimethylaniline; a molar ratio of the free radical polymerization initiator to the octa-olefin functionalized silsesquioxane is 1:(30-50); the addition reaction is performed at a temperature of 30-70° C. for a period of 8-12 h; the vacuum drying treatment is performed under a vacuum degree of 1-50 Pa at a temperature of 35-60° ° C. for a period of 4-8 h.

9. The method for preparing the ultrahigh-strength SiO₂ aerogel with the alternately configured soft chains and hard cores according to claim 3, wherein the free radical polymerization initiator is one or more of 2,2′-azobis(2-methylpropionitrile), 2,2′-azobis-(2,4-dimethylvaleronitrile), dibenzoyl peroxide, and N,N-dimethylaniline; a molar ratio of the free radical polymerization initiator to the octa-olefin functionalized silsesquioxane is 1:(30-50); the addition reaction is performed at a temperature of 30-70° C. for a period of 8-12 h; the vacuum drying treatment is performed under a vacuum degree of 1-50 Pa at a temperature of 35-60° C. for a period of 4-8 h.

10. The method for preparing the ultrahigh-strength SiO₂ aerogel with the alternately configured soft chains and hard cores according to claim 5, wherein before the hydrolysis reaction, a pH value of the second resulting mixture is adjusted to 2-4; the hydrolysis reaction is performed at a temperature of 40-70° C. for a period of 2-4 h; before the heat-induced gelation reaction, a pH value of a product obtained from the hydrolysis reaction is adjusted to 8-10; the heat-induced gelation reaction is performed at a temperature of 60-80° C. for a period of 4-6 h.

11. The ultrahigh-strength SiO₂ aerogel with alternately configured soft chains and hard cores according to claim 7, wherein in the method, the octa-olefin functionalized silsesquioxane is octavinyl-polyhedral oligomeric silsesquioxane or acrylo-polyhedral oligomeric silsesquioxane; the mercapto silane coupling agent is one or more of 3-mercaptopropyltrimethoxysilane, 3-mercaptopropyltriethoxysilane, 3-mercaptopropylmethyldimethoxysilane, and 3-mercaptopropylmethyldiethoxysilane; the organic solvent is one or more of diethyl ether, acetone, benzene, and toluene; a molar ratio of the octa-olefin functionalized silsesquioxane to the mercapto silane coupling agent to the organic solvent is 1:(6-10):(8-12).

12. The ultrahigh-strength SiO₂ aerogel with alternately configured soft chains and hard cores according to claim 11, wherein in step (1) of the method, the mixing is performed under a protective gas, and the protective gas is helium, argon, nitrogen, or carbon dioxide; the mixing is performed at a temperature of 40-60° C.

13. The ultrahigh-strength SiO₂ aerogel with alternately configured soft chains and hard cores according to claim 7, wherein in the method, the free radical polymerization initiator is one or more of 2,2′-azobis(2-methylpropionitrile), 2,2′-azobis-(2,4-dimethylvaleronitrile), dibenzoyl peroxide, and N,N-dimethylaniline; a molar ratio of the free radical polymerization initiator to the octa-olefin functionalized silsesquioxane is 1:(30-50); the addition reaction is performed at a temperature of 30-70° C. for a period of 8-12 h; the vacuum drying treatment is performed under a vacuum degree of 1-50 Pa at a temperature of 35-60° C. for a period of 4-8 h.

14. The ultrahigh-strength SiO₂ aerogel with alternately configured soft chains and hard cores according to claim 13, wherein in the method, the alcohol solution is a solution of an alcohol in water, wherein the alcohol is methanol, ethanol, or isopropanol, and a volume ratio of the alcohol to the water in the alcohol solution is 1:(1-2); a mass-to-volume ratio of the white powder to the alcohol solution is 1 g:(2-4) mL.

15. The ultrahigh-strength SiO₂ aerogel with alternately configured soft chains and hard cores according to claim 7, wherein in the method, before the hydrolysis reaction, a pH value of the second resulting mixture is adjusted to 2-4; the hydrolysis reaction is performed at a temperature of 40-70° C. for a period of 2-4 h; before the heat-induced gelation reaction, a pH value of a product obtained from the hydrolysis reaction is adjusted to 8-10; the heat-induced gelation reaction is performed at a temperature of 60-80° C. for a period of 4-6 h.
